(19) United States
(12) Patent Application Publication
(10) Pub. No.: US 2009/0109089 A1
(43) Pub. Date: Apr. 30, 2009

(54) System and Apparatus for Optimum GPS Reception

(75) Inventor: Yervant David Lepejian, Glendale, CA (US)

Correspondence Address: MYERS WOLIN, LLC, 100 HEADQUARTERS PLAZA, North Tower, 6th Floor, MORRISTOWN, NJ, 07960-6834, US

(73) Assignee: SOSY TECHNOLOGIES STU, INC., Santa Clara, CA (US)

(21) Appl. No.: 12/261,010

(22) Filed: Oct. 29, 2008

Related U.S. Application Data
(60) Provisional application No. 61/000,781, filed on Oct. 30, 2007.

(51) Int. Cl. H04B 7/185

(52) U.S. Cl. 342/357.06

(57) ABSTRACT

One embodiment of an apparatus for receiving a GPS signal includes a first chamber having a GPS antenna that is positionable relative to a second chamber having a GPS receiver, a communication path extending between the first and second chambers for connecting the GPS antenna and the GPS receiver, and a lock for fixing the relative movement of the first and second chambers, wherein the first chamber is positioned relative to the second chamber for optimum reception of the GPS signal by the GPS antenna. A system including such apparatus and method of using are also disclosed.

### CROSS-REFERENCE TO RELATED APPLICATIONS

This application claims the benefit of U.S. Application 61/000,781, filed Oct. 30, 2007, which is hereby incorporated by reference for all that it contains.

### FIELD OF THE INVENTION

Optimizing global positioning system (GPS) reception in GPS receivers.

### BACKGROUND

Global positioning system (GPS) receivers today are generally recognized as commodity items. There are receivers that have antenna built into the receiver as a single unit, and receivers that have their antenna as a separate unit that needs to be connected to the receiver. In the case of commodity-type GPS receivers that are usually provided as part of an after-market product, there is a need for the antenna to be in the open and facing GPS satellites during operation. This need for the antenna to be in an exposed location for operation is recognized as a limitation for the operation of GPS receivers. This is especially true if the GPS receiver is to be connected to an on-board diagnostic (OBD) port of a vehicle, as this port is typically under the dashboard of the vehicle or in a location that is otherwise not directly exposed to GPS satellite signals.

For good reception and tracking using a GPS receiver in a vehicle, it is necessary to have the GPS antenna facing the GPS satellite. Typically, when GPS tracking is used in motor vehicles like cars, the antenna is placed outside the vehicle facing the sky or, in a location on or near the dashboard that allows the antenna to be exposed. When an integrated GPS device is used having the antenna as an integral part of the device that needs to be plugged into an on-board diagnostic (OBD) port under the dash board, for example, it is generally not possible to position the antenna for optimum reception. There is a need, therefore, for a system that enables use of a GPS receiver with a built-in antenna in a location inside a vehicle or otherwise that is not fully exposed.

### SUMMARY

One embodiment of an apparatus for receiving a GPS signal includes a first chamber having a GPS antenna that is positionable relative to a second chamber having a GPS receiver, a communication path extending between the first and second chambers for connecting the GPS antenna and the GPS receiver, and a lock for fixing the relative movement of the first and second chambers, wherein the first chamber is positioned relative to the second chamber for optimum reception of the GPS signal by the GPS antenna. The apparatus allows the antenna to be rotated and positioned facing the sky for maximum and optimum reception with a locking mechanism that allow the antenna to retain its position in a vibrating or unstable environment. A system including such apparatus and method of using are also provided.

### BRIEF DESCRIPTION OF THE DRAWINGS

FIG. 1 is one embodiment of an apparatus of the invention.

FIG. 2 illustrates the apparatus of FIG. 1 adjusted to maximize the reception of a GPS signal.

FIG. 3 is a schematic view of an aspect of the embodiment of FIG. 1.

FIG. 4 is a rear view of an aspect of the embodiment of FIG. 1.

FIG. 5 illustrates one embodiment of a system including the apparatus of FIG. 1 mounted to an object.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

For good reception and tracking using a global positioning system (GPS) receiver in a vehicle, it is necessary to have the GPS antenna facing the GPS satellite. Typically, when GPS tracking is used in motor vehicles like cars, to have the antenna placed outside the vehicle, facing the sky or, have the GPS system placed in a location on a dash that allows the antenna to be exposed. When an integrated GPS device is used having the antenna as an integral part of the device that needs to be plugged into an on-board diagnostic port under the dash board, it is generally not possible to position the antenna for optimum reception. An apparatus that allows the antenna to be rotated and positioned facing the sky for maximum reception with a locking mechanism that allow the antenna to retain its position in a vibrating environment is disclosed.

Any commodity all-in-one product, if it is to work as an aftermarket product which is pluggable into the on-board diagnostic (OBD) port, has to be small and compact. Since different car manufacturers provide the OBD port with different orientation and location under the dashboard or hood of the car, the product, when plugged into the OBD port, will have different orientations. This makes it difficult to have the receiving antenna for the GPS facing the sky for good reception. Today there are new antennae being developed that have very high sensitivity and can work from under the hood to achieve reception if facing in the correct direction. It is necessary to provide the capability for an antenna chamber to be rotatable such that the GPS antenna position can be optimized to receive the best signal irrespective of the orientation of the OBD port.

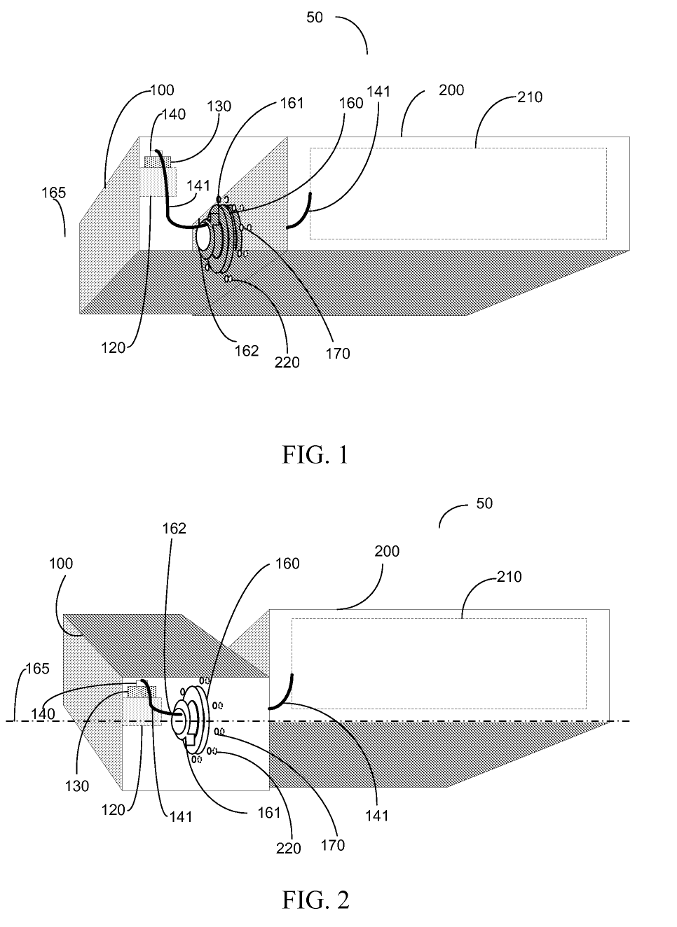

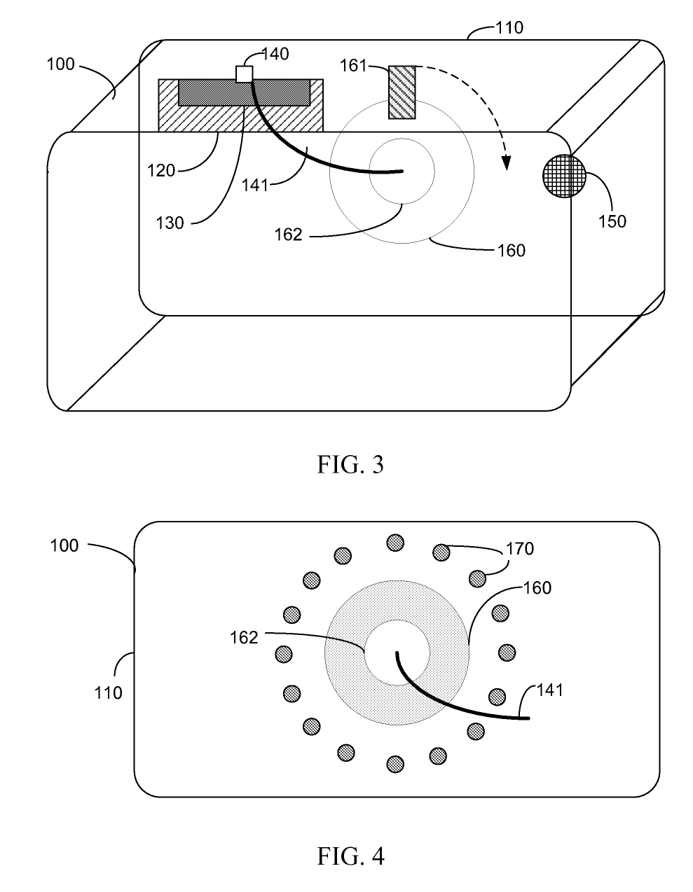

FIG. 1 illustrates one embodiment of an apparatus 50 for receiving GPS signals (not shown) that preferably has two compartments or chambers shown schematically herein, namely a first chamber 100 that preferably includes a GPS antenna (shown in FIG. 3 as antenna 140 housed on a chip 130 that is held in a chip holder 120) and a second chamber 200 that preferably includes GPS receiver circuitry 210. While FIG. 1 illustrates the first and second chambers 100, 200, and related contents, i.e., GPS antenna and receiver, in a particular orientation relative to each other, it will be understood that such contents and such orientations may be interchangeably positioned and/or varied as desired to meet the needs of a particular mounting location and/or object.

A connection cylinder 160 extends between openings 162 in the first and second chambers 100, 200 and serves two primary functions, although other functions not specifically stated herein will be recognized. First, the connection cylinder 160 provides a communication path to accommodate wiring 141 (see FIGS. 3-4) and the like for the connection of the antenna 140 in the first chamber 100 and the receiver circuitry 210 in the second chamber 200. Second, the connection cylinder 160 enables movement of the first chamber 100 relative to the second chamber 200 along an axis 165 that is coaxial with the central axis of the connection cylinder 160. Specifically, the first chamber 100 can be rotated with respect to the second chamber 200, with such rotation being limited by a key 161 on the connection cylinder 160 that limits the rotation to preferably less than 360 degrees in one direction to reduce stress on the interconnect wiring 141. This allows the first chamber 100 to be rotated so as to position the antenna 140 in a suitable angle facing a desirable orientation relative to the sky (not shown) for optimum reception as shown schematically in FIG. 2.

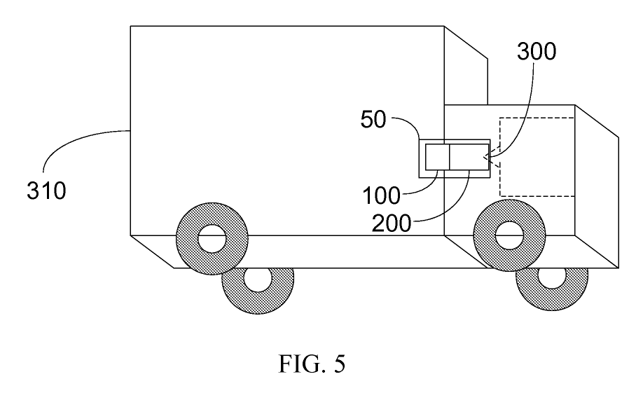

It is also preferable to have a locking mechanism that allows the first chamber 100 to be stabilized relative to the second chamber 200 so that the antenna 140 can retain its position during unstable conditions, such as when a vehicle encounters uneven terrain, bumps in the road, etc. One embodiment of a locking mechanism is shown in FIGS. 1, 2 and 4, with the provision of a plurality of protrusions 170 situated at spaced-apart and preferably fixed increments around the connection cylinder 160 at the back of the back plate of the first chamber 100 that match and mate with holes 220 on the front plate of the second chamber 200. By orienting, aligning and locking the protrusions 170 within the holes 220 at any given angle, the first chamber 100 is fixedly positioned relative to the second chamber 200. Thus, if the apparatus 50 is connected to an OBD port 300 in a vehicle 310, for example, as shown in FIG. 5, which typically has a fixed orientation relative to the vehicle 310, the antenna 140 in the first chamber can always be oriented to be facing the sky. This locking mechanism also prevents unwanted movement of the antenna 140 when the vehicle 310 is being shaken and rattled while being driven over rough terrain. Of course, while a plurality of protrusions 170 and openings 220 are preferable as shown, it will be appreciated that the locking mechanism can be operable with at least one protrusion and at least one opening, or more preferably at least one protrusion and a plurality openings for angular variation of the relative positioning of the first and second chambers 100, 200.

A reception strength indicator, such as a light emitting diode (LED) 150 (FIG. 3) or the like, can be used to indicate optimum reception by the antenna 140 during the rotation of the first chamber 100 relative to the second chamber 200, such that the intensity of the LED 150 increases with the increase in reception of the GPS signal at the antenna 140. Thus, the first chamber 100 can be rotated and then fixed in position relative to the second chamber 200 based on the intensity of the reception strength indicator 150. Other methods of indicating strength of a GPS signal, such as by a number of bars on a readout screen (not shown), etc., may be used as is known in the art.

Implementation and operation of the apparatus 50 is relatively straightforward. FIG. 5 illustrates one embodiment of a system 400 including the apparatus 50 connected to a movable object such as a vehicle 310, the vehicle 310 having an OBD port 300, with the position of the OBD port 300 being fixed relative to the vehicle 310. In one embodiment, the second chamber 200 is connected to the OBD port 300 such that the position of the second chamber 200 and OBD port 300 are similarly fixed relative to the vehicle 310. The first chamber 100 is then rotated relative to the second chamber 200 while monitoring the reception strength indicator 150 to determine an optimum reception of the GPS signal by the GPS antenna 140, and then the position of the first chamber 100 is fixed relative to the second chamber 200 by aligning the protrusions 170 with the openings 200 and using the key 161 to fix the positioning of the connection cylinder and the relative positioning of the first and second chambers.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

I claim:

1. An apparatus for receiving a global positioning system (GPS) signal comprising:
a) a first chamber comprising a GPS antenna;
b) a second chamber comprising a GPS receiver and being movable relative to the first chamber;
c) a communication path extending between the first and second chambers for connecting the GPS antenna and the GPS receiver; and
d) a lock for fixing the relative movement of the first and second chambers;
e) wherein the first chamber is positioned relative to the second chamber for optimum reception of the GPS signal by the GPS antenna.

2. The apparatus of claim 1, wherein the first chamber is rotatable relative to the second chamber along a first axis of rotation.

3. The apparatus of claim 2, wherein the first chamber is rotatable at fixed increments relative to the GPS receiver.

4. The apparatus of claim 2, further comprising at least one positioning element on the first or second chamber that extends into at least one opening on the other chamber.

5. The apparatus of claim 4, further comprising a plurality of circumferentially-arranged positioning elements at fixed increments on the first or second chamber that extend into a plurality of circumferentially-arranged openings in the other chamber.

6. The apparatus of claim 2, wherein the communication path further comprises a connecting cylinder extending between the first and second chambers that is coaxial with the first axis of rotation.

7. The apparatus of claim 6, wherein the lock further comprises a key on the connecting cylinder that fixes the relative movement of the first and second chambers.

8. The apparatus of claim 7, wherein the key limits rotation of the first chamber relative to the second chamber to less than a 360° rotation.

9. The apparatus of claim 1, further comprising a reception strength indicator for indicating the strength of the GPS signal being received by the GPS antenna.

10. The apparatus of claim 9, wherein the reception strength indicator is a light emitting diode that increases in intensity with the increase in strength of the GPS signal.

11. A method of mounting an apparatus for receiving a global positioning system (GPS) signal to a movable object, the apparatus comprising:
a) a first chamber comprising a GPS antenna, and a second chamber comprising a GPS receiver and being movable relative to the first chamber;
b) a communication path extending between the first and second chambers for connecting the GPS antenna and the GPS receiver;
c) a lock for fixing the relative movement of the first and second chambers; and
d) a reception strength indicator for indicating the strength of the GPS signal being received by the GPS antenna that increases in intensity with the increase in strength of the GPS signal;
the method comprising:
e) connecting the second chamber to the movable object;
f) moving the first chamber relative to the second chamber while monitoring the reception strength indicator to determine an optimum reception of the GPS signal by the GPS antenna; and
g) locking the position of the first chamber relative to the second chamber in a condition of optimum reception.

12. The method of claim 11, wherein the first chamber is rotatable relative to the second chamber at fixed increments along a first axis of rotation.

13. The method of claim 12, further comprising a plurality of circumferentially-arranged positioning elements at fixed increments on the first or second chamber that extend into a plurality of circumferentially-arranged openings in the other chamber.

14. The method of claim 13, wherein the communication path further comprises a connecting cylinder extending between the first and second chambers that is coaxial with the first axis of rotation.

15. A global positioning system (GPS) reception system comprising:
a) a vehicle comprising an on-board diagnostic (OBD) port; and
b) an apparatus for receiving a GPS signal comprising:
i. a first chamber comprising a GPS antenna;
ii. a second chamber comprising a GPS receiver and being rotatable relative to the first chamber;
iii. a communication path extending between the first and second chambers for connecting the GPS antenna and the GPS receiver; and
iv. a lock for fixing the relative movement of the first and second chambers;
c) wherein the apparatus is connected to the OBD port at a first location; and
d) wherein the first chamber is rotatably positioned relative to the second chamber at a different location than the first location for optimum reception of the GPS signal by the GPS antenna.

16. The system of claim 15, wherein the first chamber is rotatable at fixed increments relative to the GPS receiver.

17. The system of claim 16, further comprising a plurality of circumferentially-arranged positioning elements at fixed increments on the first or second chamber that extend into a plurality of circumferentially-arranged openings in the other chamber.

18. The system of claim 15, wherein the communication path further comprises a connecting cylinder extending between the first and second chambers that is coaxial with the first axis of rotation.

19. The system of claim 18, wherein the lock further comprises a key on the connecting cylinder that fixes the relative movement of the first and second chambers and limits rotation of the first chamber relative to the second chamber to less than a 360° rotation.

20. The system of claim 15, further comprising a reception strength indicator for indicating the strength of the GPS signal being received by the GPS antenna and that increases in intensity with the increase in strength of the GPS signal.
